(19) United States
(12) Patent Application Publication
(10) Pub. No.: US 2012/0128265 A1
(43) Pub. Date: May 24, 2012

(54) METHOD AND SYSTEM UTILIZING ITERATIVE RECONSTRUCTION WITH ADAPTIVE PARAMETERS FOR COMPUTER TOMOGRAPHY (CT) IMAGES

(75) Inventors: Michael D. SILVER, NORTHBROOK, IL (US); Alexander ZAMYATIN, HAWTHORN WOODS, IL (US); Daxin SHI, VERNON HILLS, IL (US)

(73) Assignees: TOSHIBA MEDICAL SYSTEMS CORPORATION, OTAWARA-SHI (JP); KABUSHIKI KAISHA TOSHIBA, TOKYO (JP)

(21) Appl. No.: 12/953,065

(22) Filed: Nov. 23, 2010

(51) Int. Cl. G06K 9/40

(52) U.S. Cl. 382/275

(57) ABSTRACT

The CT imaging system optimizes its image generation by adaptively weighting certain parameters during the iterations in an iterative reconstruction algorithm. The projection data is grouped into N subsets, and after each of the N subsets is processed by the ordered subsets simultaneous algebraic reconstruction technique (OSSART), the image undergoes total variation (TV) minimization process. During the iterative reconstruction algorithm, a combination of the parameters such as a total variation, a relaxation parameter and a step size parameter is assigned a respective value based upon the current value of the iteration.

### FIELD OF THE INVENTION

The current invention is generally related to an image processing method and system for adaptively processing parameters in an iterative reconstruction algorithm.

### BACKGROUND OF THE INVENTION

For volume image reconstruction, an iterative algorithm includes a total variation (TV) minimization iterative reconstruction algorithm for application to sparse views and limited angle x-ray CT reconstruction. For example, some techniques have been based upon the ordered subset simultaneous algebraic reconstruction technique (OSSART), and the SART and image update steps are repeated for each subset.

Despite the prior art efforts, some problems remain unsolved and require improvement. Prior art efforts generally reduce noise at the expense of spatial resolution. In other words, although the noise may be reduced based upon a total variation (TV) minimization iterative reconstruction algorithm, the resultant image has poor spatial resolution. On the other hand, when prior art efforts preserve spatial resolution, the noise is not sufficiently reduced. It appears that prior art total variation (TV) minimization iterative reconstruction algorithms cannot improve the noise without sacrificing spatial resolution.

In view of the above discussed prior art problems, a practical solution is still desired for implementing a total variation (TV) minimization iterative reconstruction algorithm.

### BRIEF DESCRIPTION OF THE DRAWINGS

FIG. 1 is a diagram illustrating one embodiment of the multi-slice X-ray CT apparatus or scanner according to the current invention.

FIG. 2 is a flow chart illustrating steps involved in a preferred process of the Total Variation Iterative Reconstruction (TV-IR) according to the current invention.

FIG. 3 is a flow chart illustrating steps involved in the ordered subset simultaneous algebraic reconstruction technique (OSSART) as used in a preferred process of the Total Variation Iterative Reconstruction (TV-IR) according to the current invention.

FIG. 4 is a flow chart illustrating steps involved in the line search technique as used in a preferred process of the Total Variation Iterative Reconstruction (TV-IR) according to the current invention.

FIG. 5 is a list of pseudocode illustrating one exemplary implementation Of the steps involved in a preferred process of the Total Variation Iterative Reconstruction (TV-IR) according to the current invention.

FIG. 6 is a list of pseudocode illustrating one exemplary implementation of further steps of the steps S20 in FIG. 2 for the ordered subset simultaneous algebraic reconstruction technique (OSSART) as used in a preferred process of the Total Variation Iterative Reconstruction (TV-IR) according to the current invention.

FIG. 7 is a list of pseudocode illustrating one exemplary implementation of further steps of the steps S30 in FIG. 2 for the line search technique as used in a preferred process of the Total Variation Iterative Reconstruction (TV-IR) according to the current invention.

FIG. 8A illustrates an image that has been reconstructed by filtered backprojection (FBP) from projection data having 1200 views per revolution using 100 kV and 100 mAs.

FIG. 8B illustrates an image that has been preprocessed by known procedures for noise reduction and corrections, and the preprocessed image is used as an initial seed for total variation iterative reconstruction (TV-IR) according to the current invention.

FIG. 8C illustrates an exemplary image that has gone under three iterations of the main loop as described with respect to FIG. 2 or 5.

FIG. 8D illustrates an exemplary image that has gone under a total of eight iterations of the main loop as described with respect to FIG. 2 or 5.

FIG. 8E illustrates an exemplary image that has gone under a total of thirteen iterations of the main loop as described with respect to FIG. 2 or 5.

FIG. 8F illustrates an exemplary image that has gone under a total of eighteen iterations of the main loop as described with respect to FIG. 2 or 5.

FIG. 8G illustrates an exemplary image that has gone under a total of twenty-three iterations of the main loop as described with respect to FIG. 2 or 5.

FIG. 9 is a graph illustrating a relation between the standard deviation in the image after certain iterations in the total variation iterative reconstruction (TV-IR) according to the current invention.

FIG. 10 is a table that summarizes the standard deviation data for the images as plotted in the graph of FIG. 9.

### DETAILED DESCRIPTION OF THE PREFERRED EMBODIMENT(S)

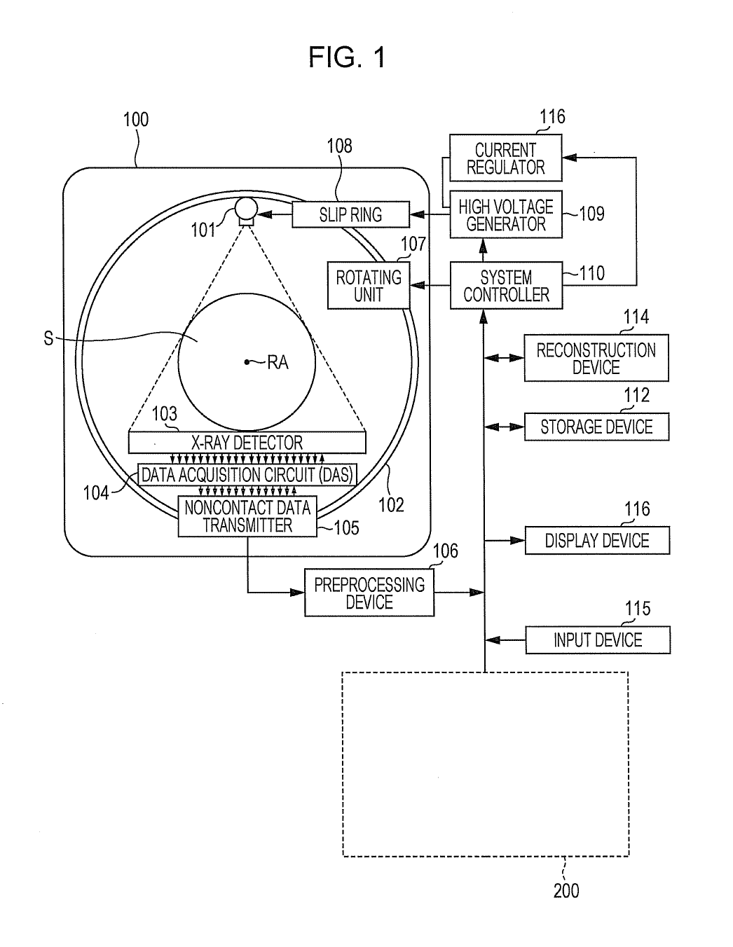

Referring now to the drawings, wherein like reference numerals designate corresponding structures throughout the views, and referring in particular to FIG. 1, a diagram illustrates one embodiment of the multi-slice X-ray CT apparatus or scanner according to the current invention including a gantry 100 and other devices or units. The gantry 100 is illustrated from a front view and further includes an X-ray tube 101, an annular frame 102 and a multi-row or two-dimensional array type X-ray detector 103. The X-ray tube 101 and X-ray detector 103 are diametrically mounted across a subject S on the annular frame 102, which rotates around axis RA. A rotating unit 107 rotates the frame 102 at a high speed such as 0.4 sec/rotation while the subject S is being moved along the axis RA into or out of the illustrated page.

The multi-slice X-ray CT apparatus further includes a high voltage generator 109 that applies a tube voltage to the X-ray tube 101 so that the X-ray tube 101 generates X ray. In one embodiment, the high voltage generator 109 is mounted on the frame 102. The X rays are emitted towards the subject S, whose cross sectional area is represented by a circle. The X-ray detector 103 is located at an opposite side from the X-ray tube 101 across the subject S for detecting the emitted X rays that have transmitted through the subject S.

Still referring to FIG. 1, the X-ray CT apparatus or scanner further includes other devices for processing the detected signals from X-ray detector 103. A data acquisition circuit or a Data Acquisition System (DAS) 104 converts a signal output from the X-ray detector 103 for each channel into a voltage signal, amplifies it, and further converts it into a digital signal. The X-ray detector 103 and the DAS 104 are configured to handle a predetermined total number of projections per rotation (TPPR).

The above described data is sent to a preprocessing device 106, which is housed in a console outside the gantry 100 through a non-contact data transmitter 105. The preprocessing device 106 performs certain corrections such as sensitivity correction on the raw data. A storage device 112 then stores the resultant data that is also called projection data at a stage immediately before reconstruction processing. The storage device 112 is connected to a system controller 110 through a data/control bus, together with a reconstruction device 114, display device 116, input device 115, and the scan plan support apparatus 200. The scan plan support apparatus 200 includes a function for supporting an imaging technician to develop a scan plan.

One embodiment of the reconstruction device 114 further includes various software and hardware components. According to one aspect of the current invention, the reconstruction device 114 of the CT apparatus advantageously minimizes total variation (TV) using an iterative reconstruction technique. In general, the reconstruction device 114 in one embodiment of the current invention performs the total variation iterative reconstruction (TVIR) algorithm for reconstructing an image. In further detail, the reconstruction device 114 performs on the projection data an ordered subset simultaneous algebraic reconstruction technique (OSSART) process and a TV minimization process. One embodiment of the reconstruction device 114 sequentially performs two processes that are implemented in a main loop where a first predetermined number of iterations is prescribed and in an inner loop where a second predetermined number of iterations is adaptively prescribed for a given iteration of the main loop. In other words, the reconstruction device 114 iterates the inner loop for a different number of times according to a given iteration of the main loop.

Before the TV minimization process, the reconstruction device 114 performs on the projection data an ordered subsets simultaneous algebraic reconstruction technique (OSSART). The projection data is grouped into a predetermined number of subsets N each having a certain number of views. During the OSSART, each subset may be sequentially processed in one embodiment. In another embodiment, a plurality of the subsets may be processed in parallel by taking advantage of certain microprocessor such as multiple central processing units (CPU) or a graphics processing unit (GPU). In yet another embodiment, the reconstruction device 114 performs on the projection data an ordered subsets simultaneous algebraic reconstruction technique (OSSART) with a relaxation parameter. A predetermined value is optionally assigned to the relaxation parameter for a given iteration of the main loop. In other words, the reconstruction device 114 weights the result using a different parameter value according to a given iteration of the main loop in the OSSART.

During the ordered subsets simultaneous algebraic reconstruction technique (OSSART), the reconstruction device 114 also performs two major operations. Namely, for each subset N, the reconstruction device 114 re-projects the image volume to form the computed projection data and back-projects the normalized difference between the measured projection and the computed projection data to reconstruct an updated image volume when added to the current image estimate. In further detail, one embodiment of the reconstruction device 114 re-projects the image volume by using the ray tracing technique where no coefficient of the system matrix is cached. Moreover, one embodiment of the reconstruction device 114 simultaneously re-projects all rays in a subset, and this is optionally implemented in parallel. Other embodiments include the system model and the noise model. In the back-projection, one embodiment of the reconstruction device 114 uses a pixel-driven technique to back-project all of the normalized difference projection data in a subset to form the desired updated image volume. Because the reconstruction device 114 back-projects all ray sums, i.e., difference projection data, in a subset to form an image volume, this operation is optionally implemented in parallel too. These operations are applied to every subset N to complete a single OSSART step. This and other embodiments are optionally included in the scope of the current invention as more particularly claimed in the appended claims.

In the total variation (TV) minimization process, one embodiment of the reconstruction device 114 employs a line search strategy to search a positive step size so as to ensure the objective function of the current image volume to be smaller than that of the previous image volume. According to this strategy, one embodiment of the reconstruction device 114 generates a variable step size in the TV minimization step. In addition, the search direction is a negative normalized gradient in one embodiment, while the search direction is optionally not normalized in another embodiment of the current invention. One embodiment of the reconstruction device 114 adaptively assigns a particular value to the initial step size for a given iteration of the main loop. Another embodiment of the reconstruction device 114 assigns a fixed value to the initial step size of the TV minimization step for every iteration of the main loop.

One embodiment of the reconstruction device 114 adjusts a parameter called “TV steps” to balance the resolution and the noise. This adjustment operation is implemented in TV minimization step. One embodiment of the reconstruction device 114 repeats the TV minimization step for a predetermined number of times to suppress noise at the expense of some spatial resolution. One embodiment of the reconstruction device 114 adaptively assigns a particular value to the repetitions of the TV minimization step for a given iteration of the main loop. Another embodiment of the reconstruction device 114 advantageously determines a tradeoff between resolution and noise and assigns a fixed value to the repetitions of the TV minimization step for every iteration of the main loop.

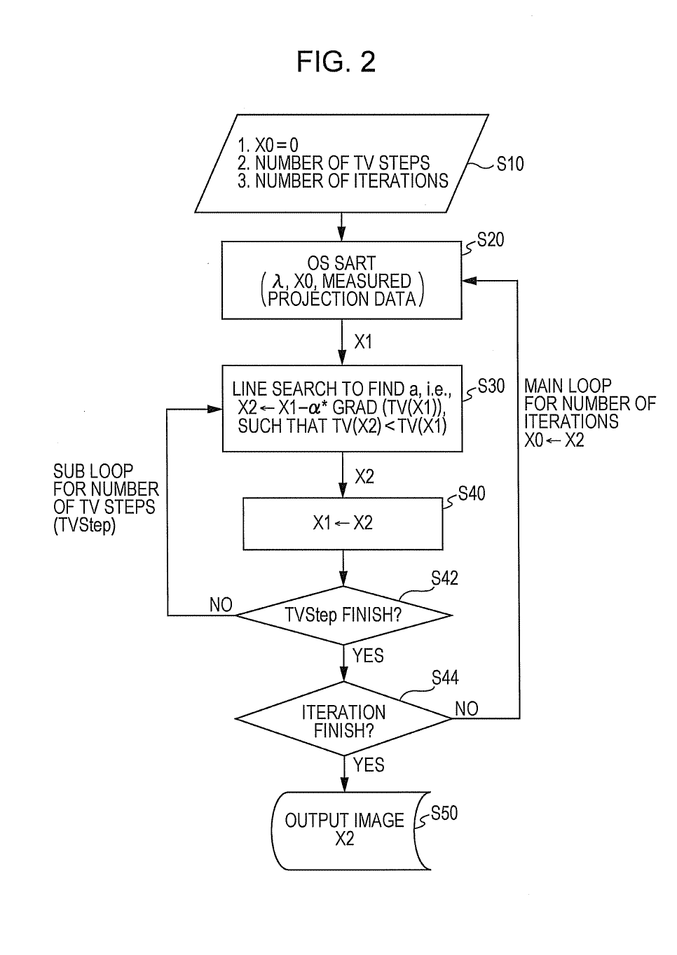

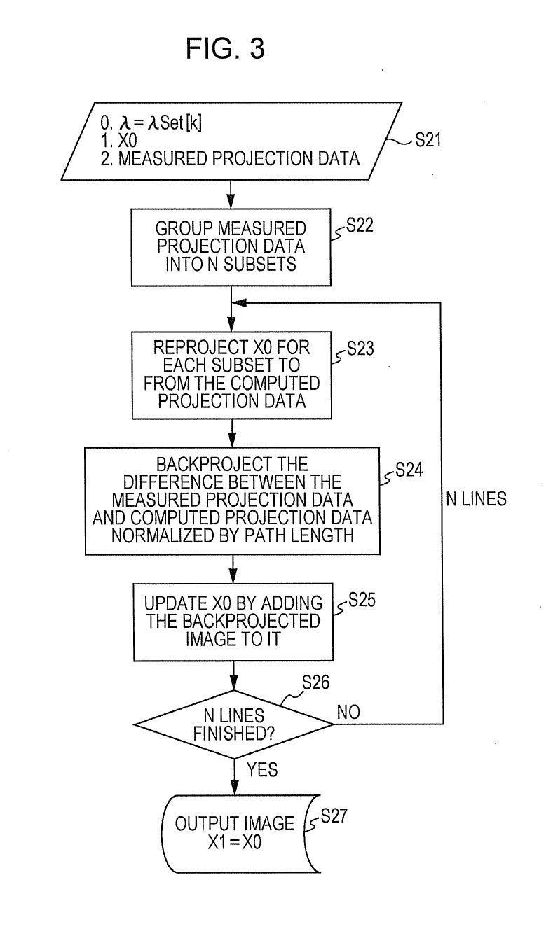

Now referring to FIG. 2, a flow chart illustrates steps involved in an exemplary process of total variation iterative reconstruction (TV-IR) according to the current invention. In an initialization step S10, an image X0 is initialized to 0. In the same step, a value indicating a number of iteration is initialized to a first predetermined number K, and a current number of iterations is kept in an iteration counter or a main-loop counter k. In a step S20, an ordered subset simultaneous algebraic reconstruction technique (OSSART) with a relaxation parameter is performed on the measured projection data in an exemplary process of the TV-IR according to the current invention. The step S20 outputs an intermediate image X1. The detailed steps of the OSSART will be further described with respect to FIG. 3 below.

The illustrated exemplary process includes two loops where certain steps are repeated and or iteratively performed. The first loop is the main or outer loop that includes steps S20, S30 and S40. The main loop is repeated according to the first predetermined number K that is assigned to the main-loop counter k in the step S10 according to the exemplary process. As each repetition of the main loop is completed, the main-loop counter k is decremented by one from the initial value K. In one exemplary process, the first predetermined number K is optionally determined based upon a number of ordered subsets Nₛₑₜₛ of the projection data, which will be further described with respect to FIG. 3.

Within the main loop, an ordered subsets simultaneous algebraic reconstruction technique (OSSART) with relaxation parameter \lambda is applied to projection data in a step S20. A weight value is stored in a relaxation parameter λ for the OSSART. The weight value is adaptively assigned to the relaxation parameter λ in the step S20 based upon a value of the main-loop counter k according to the exemplary process. For example, for the first iteration (k=1) of the main loop, a value of XX is assigned to the relaxation parameter λ as a weight. Similarly, for the second iteration (k=2) of the main loop, another value of YY is assigned to the relaxation parameter λ as a weight. A series of weight values such as XX and YY is optionally stored in a first predetermined record structure λSet[k] with an index k that corresponds to a value of the main-loop counter k for the main loop. In one example, the relaxation parameter λ has a value range from 0.2 to 1.

The second loop is the sub or inner loop that includes the steps S30 and S40. The sub loop is also called a total variation step (TVstep) loop. The sub loop is repeated according to a second predetermined number S that is also adaptively assigned to a total variation counter or a sub-loop counter s in a step S25 based upon a current value of the main-loop counter k for the main loop according to the exemplary process. For example, for the first iteration (k=1) of the main loop, a value of WW is assigned to the sub-loop counter s as a number that the sub loop is repeated. Similarly, for the second iteration (k=2) of the main loop, a value of ZZ is assigned to the sub-loop counter s as a number that the sub loop is repeated. The steps S30 and S40 are repeated in the sub loop for the adaptively assigned second number of times S. As each repetition of the sub loop is completed, the sub-loop counter s is decremented by one from the initial value S. A series of sub-loop repetition values such as WW and ZZ is optionally stored in a second predetermined record TVSet[k] with an index k that corresponds to a value of the main-loop counter k of the main loop. In one example, the sub-loop counter s has a value range from 3 or 5 to 0 or 1.

In the step S30, a line search method is iteratively performed in order to minimize the total variation based upon the adaptively assigned second number of times S. As the step 30 is finished, an image X2 is generated from the intermediate image X1 from the step S20. The image generated in the step S30 is assigned to an intermediate image holder or variable X1 in the step S40.

In a step S42, it is decided based upon the sub-loop counter s as to whether or not the sub loop is completed. If it is decided that the sub loop is completed in the step S42, it is further determined in a S44 as to whether or not the steps S20 through S40 are to be repeated in the main loop. On the other hand, if it is decided in the step S42 that the sub loop is not yet completed, the steps S30 and S40 are repeated in the sub loop.

In the step S44, it is decided based upon the main loop counter k as to whether not the main loop is completed. If it is decided that the main loop is completed in the step S44, the image X2 is outputted in a step S50. On the other hand, if it is decided in the step S44 that the main loop is not yet completed, the steps S20, S30 and S40 are repeated in the main loop.

Now referring to FIG. 3, a flow chart illustrates further acts or sub steps in the step S20 of FIG. 2, and these steps are involved in the ordered subset simultaneous algebraic reconstruction technique (OSSART) with a relaxation parameter as used in an exemplary process of the total variation iterative reconstruction (TV-IR) according to the current invention. The illustrated process of the OSSART includes one loop where certain steps are repeated and iteratively performed. The loop includes steps S23, S24 and S25 and is repeated according to a predetermined number Nₛₑₜₛ rather than a certain condition is met. When the loop is finished, the OSSART outputs the intermediate image in the variable X1.

Still referring to FIG. 3, each of the steps S21 through S26 is generally described below. In a step S21, the image X0 and measured projection data p are available from through the step S20 of FIG. 2. In addition, the adaptively assigned weight value is also available in the step S21 through the relaxation parameter λ as described with respect to the step S20 in FIG. 2. In one implementation, one of the stored weight values in the first predetermined record structure is selected based on an index k that corresponds to a value of the main-loop counter k of the main loop.

In a step S22, the measured projection data p is partitioned into Nₛₑₜₛ groups called subsets. The number of subsets Nₛₑₜₛ is based upon a certain rule that the total number of views is divided by a predetermined number of subviews. For example, if the projection data have 1200 views in total and a predetermined number of subviews is 15, a number of subsets is 80 (1200/15=80). Alternatively, the number of views in each subset optionally changes. For a fixed number of total views, if a number of subsets is relatively small due to a large number of subviews, the image will converge slowly and requires more iterations in the main loop. On the other hand, if a number of subsets is relatively large due to a small number of subviews, the image will converge fast and requires less iterations. At the same time, the image includes more noise. Based upon the above relationship, a value of the first predetermined number K is optionally modified in the step S10 of FIG. 2.

Each of the subsets Nₛₑₜₛ contains a number of subrays N_{subrays}, which is determined by dividing a total number of arrays N_{rays} by the subsets Nₛₑₜₛ. For each of the subsets Nₛₑₜₛ, a step S23 re-projects the image X0 to form the computed projection data while a step S24 back-projects the normalized difference between the measured projection data and the computed projection data. In further detail, one exemplary process of the step S23 re-projects the image volume by using the ray tracing technique where no coefficient of the system matrix is cached. Moreover, one embodiment of the step S23 simultaneously re-projects all rays in a subset, and this is optionally implemented in parallel. In the back-projection, one embodiment of the S24 uses a pixel-driven technique to back-project all of the normalized difference projection data in a subset to form the desired updated image volume. Because the step S24 back-projects all ray sums, i.e., the normalized difference projection data, in a subset to form an image volume, this operation is optionally implemented in parallel. These operations are applied to every subset Nₛₑₜₛ to complete a single OSSART step. After a subset counter is initialized to Nₛₑₜₛ, the subset counter is decremented by one as each operation is completed.

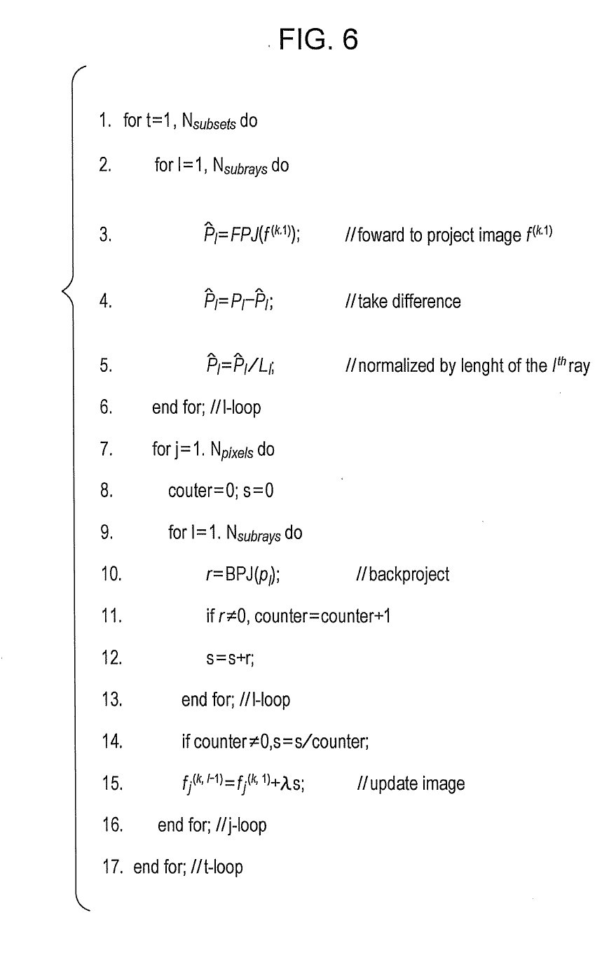

Still referring to FIG. 3, a step S25 updates the image X0 by adding the weighted back-projected image from the step S24 to the image X0. To weight the back-projected image, the relaxation parameter λ is used as will be further described with respect to FIG. 6. Consequently, it is determined in a step S26 as to whether or not the Nₛₑₜₛ have been already completed. If it is determined based upon the in the step S26 that the Nₛₑₜₛ have not already completed, the loop is repeated by proceeding to the step 23. On the other hand, if it is determined in the step S26 that the Nₛₑₜₛ have already completed, the image generated in the step S25 is assigned to an intermediate image holder or variable X1 before the image X1 is outputted in a step S27.

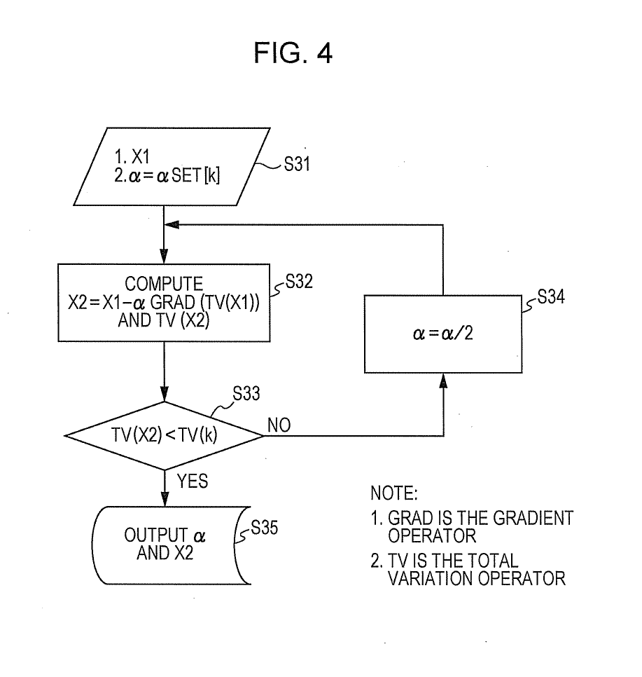

Now referring to FIG. 4, a flow chart illustrates further steps of the step S30 in FIG. 2, and these steps include the line search technique as used in a process of the total variation iterative reconstruction (TV-IR) according to the current invention. The illustrated process of the line search technique includes the sub loop where certain steps are repeated and iteratively performed. The sub loop includes steps S32, S33 and S34 and is repeated according to the predetermined number of times S rather than a certain condition is met. When the sub loop is finished, the line search technique returns the image in the variable X2 and a step size in variable α.

Still referring to FIG. 4, each of the steps S31 through S35 is generally described below. In a step S31, the image X1 is availed from the step S20 through the step S30 of FIG. 2. In addition, in the same step, a step size parameter α is initialized to a predetermined value A based upon the main-loop counter k. In one implementation, one of the stored weight values in the third predetermined record structure αSet[k] is selected based on an index k that corresponds to a value of the main-loop counter k of the main loop. In one example, the step size variable α has a value range from 1 to 0.01.

In a step S32, the image X2 is computed according to the equation, X1−α*grad(TV(X1)), where α is the step size variable, grad is a predetermined gradient operator, and TV is a predetermined total variation operator. Similarly, in the same step, after the image variable X2 has been newly assigned, TV(X2) is computed where TV is the same predetermined total variation operator. In a step S33, the previously obtained values of TV(X2) and TV(X1) are compared. If TV(X2)<TV(X1) is not true, the current step size value is reduced to a half in a step S34, the line search routine continues to the step S32. On the other hand, if TV(X2)<TV(X1) is true, the current step size value a and the image X2 are outputted in a step S35. In other words, the above described steps S32, S33 and S34 are repeated until TV(X2)<TV(X1) becomes true.

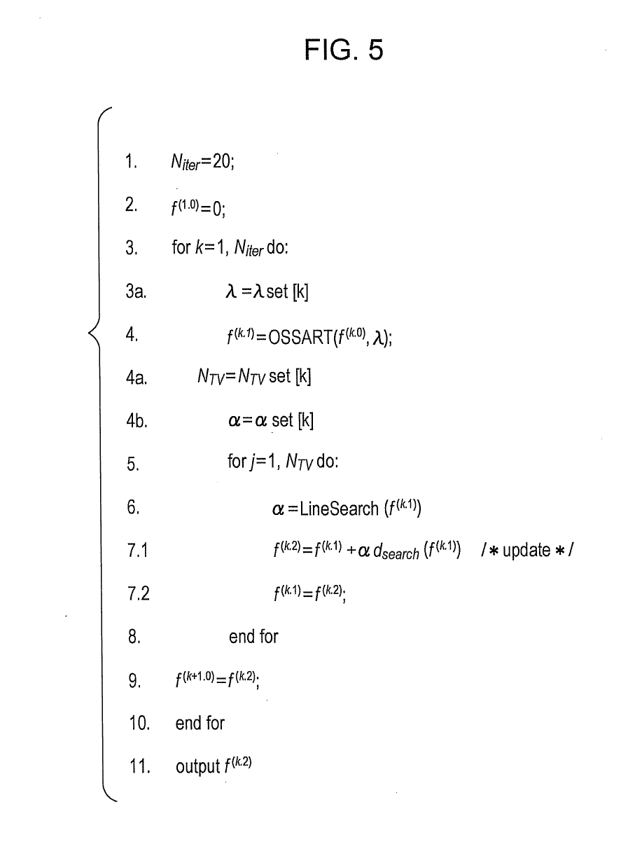

FIG. 5 is a list of exemplary pseudocode is illustrated for implementing the steps involved in a preferred process of the total variation iterative reconstruction (TV-IR) according to the current invention. The procedure has two parameters to determine a first number of iterations for the main loop in lines 3 through 10 and a second number of iterations for the sub-loop or the total variation (TV) steps in lines 5 through 8. These iterations control the image appearance. The number of the repeated TV steps is used to generally suppress a noise level. In the pseudocode, the numbers of iterations for the main loop and the number of TV steps are respectively denoted by Nᵢₜₑᵣ and N_{TV}. In general, Nᵢₜₑᵣ is inversely proportional to the number of projection views while N_{TV} is proportional to the noise level. Note that no clear convergence criteria are defined to terminate the program. In stead, the program iterates a certain predetermined number of times before it stops.

In one exemplary implementation according to the current invention, the main-loop counter k is set to one and repeated until a predetermined number Nᵢₜₑᵣ at line 1. For example, if the number of views is more than 900 and the projection data is generally clean, a value of 20 is set to Nᵢₜₑᵣ to indicate a number of iterations for the main loop. In another exemplary implementation, a number of iterations Nᵢₜₑᵣ is determined based upon a number of the subsets Nₛₑₜₛ as described with respect to the step 22 of FIG. 3. At line 2, the image f^{(1,0)} is initialized to zero or FBP seed with or without noise deduction.

Still referring to FIG. 5, there are three other variables that are adaptively assigned their values based upon a current iteration value K in the main-loop counter k At line 3a, a first adaptive parameter is the relaxation parameter λ, which is assigned a value from the first record λ[k], where k is an index that corresponds to the current value K of the main-loop counter k. The relaxation parameter λ is passed to the OSSART routine along with the image f^{(k,0)} at line 4. The second adaptive parameter is the sub-loop counter j for counting a number of repetitions for the sub-loop until a number N_{TV}, which is assigned at line 4a a value from the second record NTV[k], where k is an index that corresponds to the current value K of the main-loop counter k. At line 4b, a third adaptive parameter is the step size parameter α, which is assigned a value from the third record αSet[k], where k is an index that corresponds to the current value K of the main-loop counter k. The step size parameter α is passed to the LineSearch routine along with the image f^{(k,1)} at line 6.

The sub-loop is repeated for a number of iterations Ntv. The sub-loop includes the lines 5, 6, 7.1, 7.2 and 8. The LineSearch routine is iteratively called at line 6 within the sub-loop. The step size value is returned in the step size parameter α at the line 6. The image f is updated at the line 7.1 based upon the returned step size parameter a and the current image f^{(k,1)}. At the line 7.2, the updated image f^{(k,2)} is stored in an image variable f^{(k,1)}. After the sub-loop is completed, the current updated image f^{(k,2)} is stored in the image f^{(k,1)} the main loop at the line 9. After the main-loop is completed, the current updated image f^{(k,2)} is outputted at the line 11.

To understand the pseudocode, an image f is expressed in the following equation (1) in terms of a system matrix A and projection data as denoted by a column vector p.

p=Af (1)

The image f has dimensions YDIM×XDIM for two-dimension (2D) and ZDIM×YDIM×XDIM dimensions for three-dimension (3D). Thus, the image is respectively represented by a 2D matrix f_{YDM,XDIM} and a 3D matrix f_{ZDIM,YDIM,XDIM}. In describing the forward projection procedure, the image f is rearranged as a column vector that has YDIM×XDIM elements for 2D and ZDIM×YDIM×XDIM elements for 3D. Nₚᵢₓₑₗₛ is used to represent the total number of pixels in the image, i.e., Nₚᵢₓₑₗₛ=YDIM×XDIM in the 2D case and Nₚᵢₓₑₗₛ=ZDIM×YDIM×XDIM in the 3D case.

The projection data p has VIEWS or a number of projection views, and each of the VIEWS has rays that correspond to a number of CHANNELS in the 2D data. In addition, the 3D case, has a number of rays that corresponds to a product of CHANNELS×SEGMENTS, which indicates an additional dimension. Thus, if the total number of rays is denoted by N_{rays}, the 2D projection data has N_{rays}=VIEWS×CHANNELS while the 3D projection data has N_{rays}=VIEWS×SEGMENTS×CHANNELS. The projection data is denoted by the column vector p that has N_{rays} elements. The ith element of p is denoted by pᵢ which is the i^{th} ray sum.

The system matrix A is of dimension N_{rays} Nₚᵢₓₑₗₛ and its entry is denoted by aᵢⱼ. Thus, the i^{th} ray sum can be represented as follows in Equation (2).

$${p}_{i} = {\sum }_{j = i}^{Npixels} {a}_{ij} {f}_{j} . \qquad ( 2 )$$

It is costly to store all of the entries in the matrix A due to its huge dimension. For example, if 900 views are measured with 896 channels in each view and an image matrix of size 512×512 is to be reconstructed, the matrix A will have dimension 806, 400×262, 144. It should be noted that although the matrix A is sparse, it is still costly to store the entire matrix. One way to avoid storing the system matrix A is to compute the entries on the fly if we do not need its transpose. In one prior art approach, only the coefficients of one ray are computed and stored, and the image volume is updated for each ray. In one exemplary implementation according to the current invention, the system matrix A is not stored while we interpret its transpose as the back-projection operator.

The cost function (or objective function) is the total variation (TV) as defined below in Equation (3) for the 2D case and Equation (4) for the 3D case. The variable e is a small quantity to prevent each term u(·) in the summation from vanishing because they will be divided in the formula of search direction. Note that Equations (3) and (4) represent the l¹ norm of a sequence of discrete gradient.

$$\begin{matrix}\begin{matrix}{U}_{TV} ( f ) = {\sum }_{k , l}^{ } \sqrt{{( {f}_{k + 1 , l} - {f}_{k , l} )}^{2} + {( {f}_{k , l + 1} - {f}_{k , l} )}^{2} + {ɛ}^{2}} \\ = {\sum }_{k , l}^{ } u ( k , l )\end{matrix} & ( 3 ) \\ \begin{matrix}{U}_{TV} ( f ) = {\sum }_{k , m , n}^{ } \sqrt{\begin{matrix}{( {f}_{k + 1 , m , n} - {f}_{k , m , n} )}^{2} + {( {f}_{k , m + 1 , n} - {f}_{k , m , n} )}^{2} + \\ {( {f}_{k , m , n + 1} - {f}_{k , m , n} )}^{2} + {ɛ}^{2}\end{matrix}} \\ = {\sum }_{k , m , n}^{ } u ( k , m , n )\end{matrix} & ( 4 )\end{matrix}$$

Now referring to FIG. 6, a list of exemplary pseudocode is illustrated for implementing further steps and acts of the OSSART routine at line 4 in FIG. 5. These lines of the pseudocode implement the ordered subset simultaneous algebraic reconstruction technique (OSSART) as used in an exemplary process of the total variation iterative reconstruction (TV-IR) according to the current invention. In general, although the well studied OSSART has been considered, the exemplary implementation of the OSSART according to the current invention is a variant of projection on convex sets (POCS) as described in prior art. In the current implementation, the exemplary implementation is not intended to prove a particular OSSART is a correct POCS operation. The advantage of the OSSART is that it is optionally implemented to be in parallel. In the exemplary implementation of the OSSART, the system matrix A is not cached.

Still referring to FIG. 6, in the OSSART routine, the projection data p is partitioned into subsets N_{subsets}. The t^{th} subset is denoted by Sₜ, which contains N_{subrays}=N_{rays}/N_{subsets} ray sums. For each of the subsets N_{subsets}, the steps at lines 1 through 17 are repeated in a main loop within the OSSART routine. Within the main loop, there are three sub-loops that include the lines 2 through 6, the lines 9 through 13 and the lines 7 through 16. The first sub-loop perform a forward projection of the image f^{(k,1)} for each sub ray by calling the function FPJ to generated the forward projected projection image \hat{P}l at the line 3. The difference between the forward projected image \hat{P}l and the projection data Pl is calculated in the line 4, and the difference \hat{P}l is normalized by the length of the lth ray Lₗ in the line 5. The above described operation in the first sub-loop is repeated for the N_{subrays} times for each sub ray.

For each of pixels Nₚᵢₓₑₗₛ, a second sub-loop is performed and further includes the following third sub-loop. After both a variable “counter” and a temporary variable s are initialized to zero, a third sub-loop is performed for a number of pixels Nₚᵢₓₑₗₛ within the second sub-loop. The third sub-loop in turn performs a backprojection of the projection data Pl for each sub ray by calling the function BPJ to generated the back projected projection image r at the line 10. If the value of the back projected projection image r is not zero, the counter variable is incremented by one at the line 11 while the temporary variable s is assigned to the back projected projection image r plus a previous back projected projection image s at the line 12. The above described operation in the third sub-loop is repeated for the N_{subrays} times for each sub ray. At the line 14, if the counter value is not zero, the temporary variable s is divided by the value of the counter. At the line 15, the image fⱼ^{(k,l-1)} is updated by assigning fⱼ^{(k,l)}+λs before another pixel is processed. The adaptive relaxation parameter λ has been assigned a value from the first record λ[i], where i is an index that corresponds to the current value K of the main-loop counter k in FIG. 5.

After every one of the subsets N_{subsets} is processed in the main loop at lines 1 through 17, the OSSART routine ends. That is, every subset is processed in the first, second and third sub-loops. The OSSART routine returns the result of the above described image processing.

The t^{th} subset is denoted by Sₜ, which contains N_{subrays}=N_{rays}/N_{subsets} ray sums. Mathematically, the update formula of OSSART is given by Equation (5) below:

$${f}_{j}^{( k , j + 1 )} = {f}_{j}^{( k , t )} + {λ}^{( k )} \frac{{\sum }_{l = 1}^{Nsubrays} {a}_{ij} \frac{{p}_{l} - {\sum }_{m = 1}^{Npixels} {a}_{lm} {f}_{m}^{( k , t )}}{{\sum }_{m = 1}^{Npixels} {a}_{lm}}}{{\sum }_{l = 1}^{Nsubrays} {a}_{ij}} , \\ t = 1 , … , Nsubsets \qquad ( 5 )$$

where the coefficients of the system matrix A and the projection data p correspond to the rays in the subset Sₜ. Note that although the transpose of the system matrix A is needed in the above formula, the exemplary implementation according to the current invention does not store the coefficients of system matrix A and treats the transpose operation as the back-projection operator. In Equation (5), the following three terms are further explained in Equations (5a) (5b) and (5c).

$${\hat{p}}_{i} ≡ {\sum }_{m = 1}^{Npixels} {a}_{lm} {f}_{m}^{( k , t )} \qquad ( 5 a )$$

The first term is the reprojection of the image f^{(k,t)}.

$${L}_{l} ≡ {\sum }_{m = 1}^{Npixels} {a}_{l , m} \qquad ( 5 b )$$

The second term is the length of l^{th} ray.

$${C}_{j} ≡ {\sum }_{l = 1}^{Nsubrays} {a}_{ij} , \qquad ( 5 c )$$

The third term may be viewed as the number of times a particular j^{th} pixel has been back-projected.

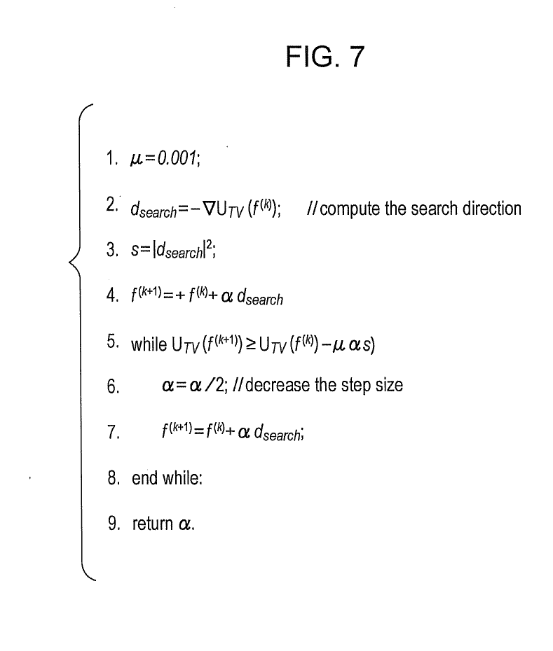

Now referring to FIG. 7, a list of exemplary pseudocode is illustrated for implementing further steps of the steps S30 in FIG. 2, and these steps are involved in the line search technique as used in a preferred process of the Total Variation Iterative Reconstruction (TV-IR) according to the current invention. By the same token, the list of exemplary pseudocode in FIG. 7 further illustrates the function, “LineSearch” on the line 6 of the pseudocode in FIG. 5.

At line 1, μ is some scalar satisfying 0<μ<1 . In the exemplary implementation, the value is set to μ=0.001. On the other hand, the adaptive step size parameter α has been already assigned its value at line 4b in FIG. 5. That is, the adaptive step size parameter a has been assigned a value from the third record αSet[k], where k is an index that corresponds to the current value K of the main-loop counter kin FIG. 5.

At line 2, the search direction is used in the gradient descent method to minimize the cost function as previously described in Equations (3) and (4). The search direction d_{search} is defined in Equation (6) as:

d_{search}(f)=−∇U_{TV} (f) (6)

which is represented as a column vector of Nₚᵢₓₑₗₛ elements. This is shown by Equations (7) and (8) respectively for 2D and 3D.

$$\begin{matrix}\frac{\partial {U}_{TV} ( f )}{\partial {f}_{k , j}} = \frac{{f}_{k , j} - {f}_{k - 1 , l}}{u ( k - 1 , l )} + \frac{{f}_{k , j} - {f}_{k , l - 1}}{u ( k , l - 1 )} - \frac{{f}_{k + 1 , l} + {f}_{k , l + 1 -} 2 {f}_{k , l}}{u ( k , l )} \\ and & ( 7 ) \\ \frac{\partial {U}_{TV} ( f )}{\partial {f}_{k , m , n}} = \frac{{f}_{k - 1 , l , m , n} - {f}_{k , m , n}}{u ( k - 1 , m , n )} + \frac{{f}_{k , m - 1 , n - 1} - {f}_{k , m , n}}{u ( k , m - 1 , n )} + \frac{{f}_{k , m , n - 1} + {f}_{k , m , n}}{u ( k , m , n - 1 )} - \frac{{f}_{k + 1 , m , n} + {f}_{k , m + 1 , n} + {f}_{k , m , n + 1} - 3 {f}_{k , m , n}}{u ( k , m , n )} & ( 8 )\end{matrix}$$

In the 2D case, only three terms in Equation (3), namely, u(k−1, l), u(k, l−1) and u(k, l), contain the variable f_{k,l} and these terms are differentiated only with respect to f_{k,l} to obtain with Equation (7).

At line 3, the variable s is assigned square of the absolute value of the search direction d_{search}. At lines 4 and 7, the object function is updated. At lines 5 and 6, the adaptive step size parameter α is halved while U_{TV}(f^{(k+1)})≧U_{TV}(f^{(k)})−μs. The line search technique is employed to find a step size α, the step size α is used in the update formula as seen in Equation (9) or line 7.1 of the pseudocode in FIG. 5.

f^{(k+1)}=f^{(k)}+αd_{search}(f^{(k)}) (9)

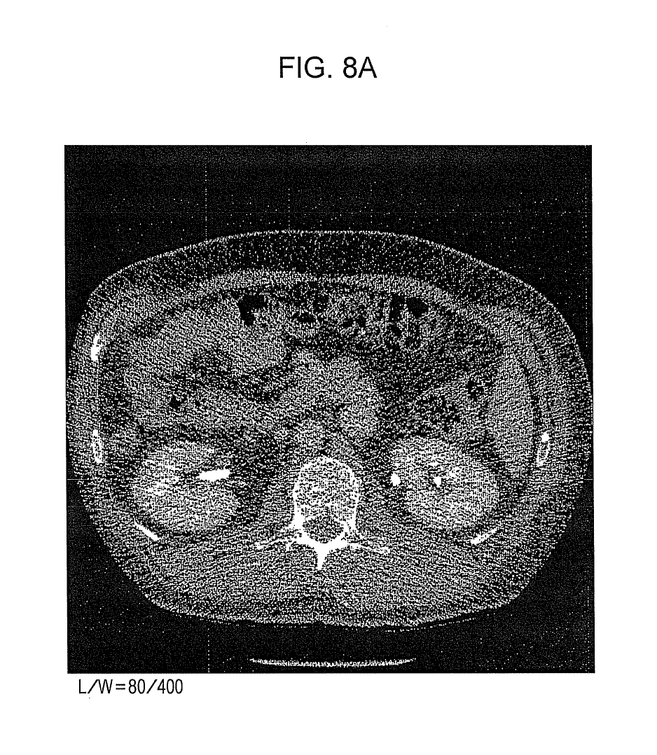

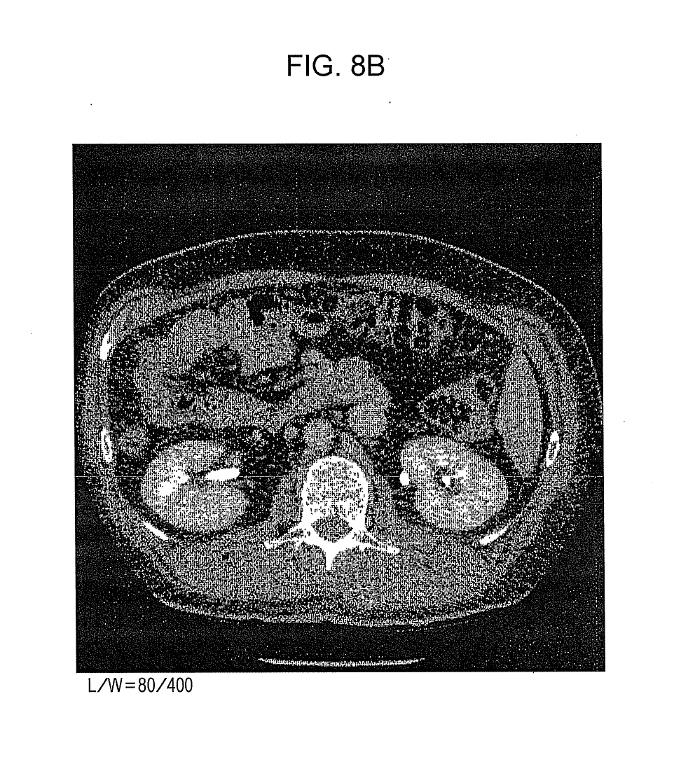

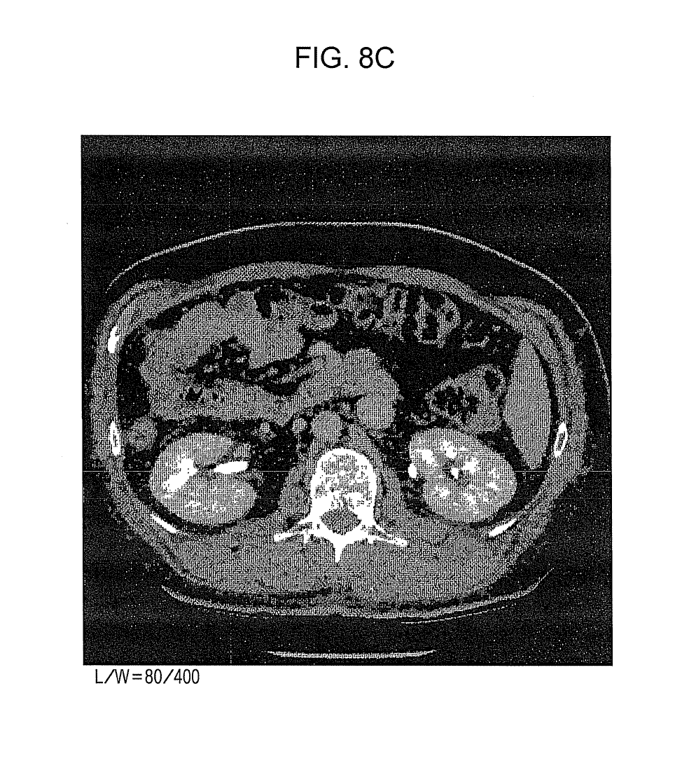

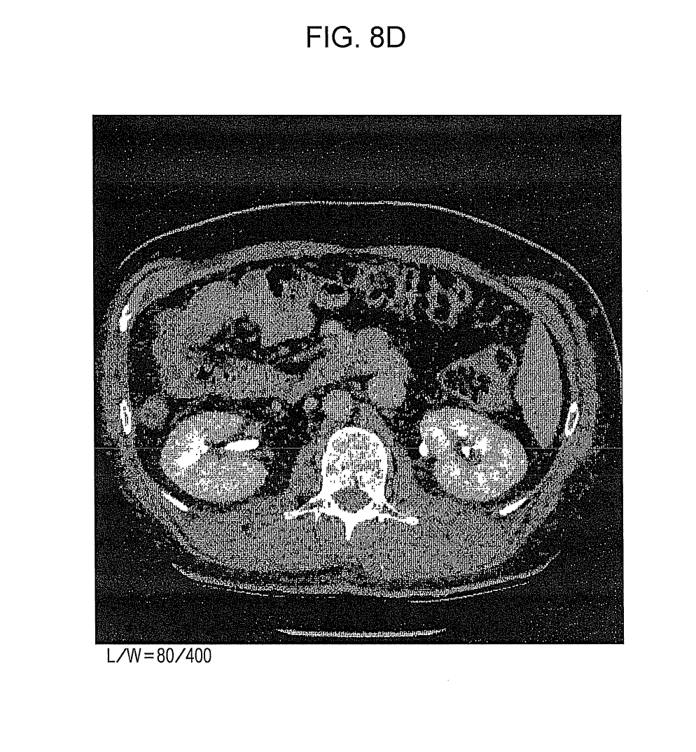

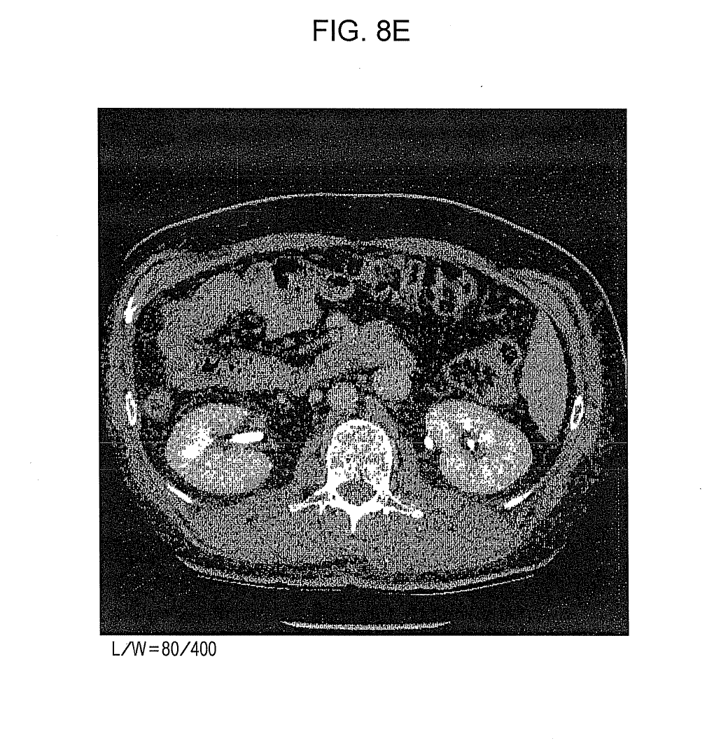

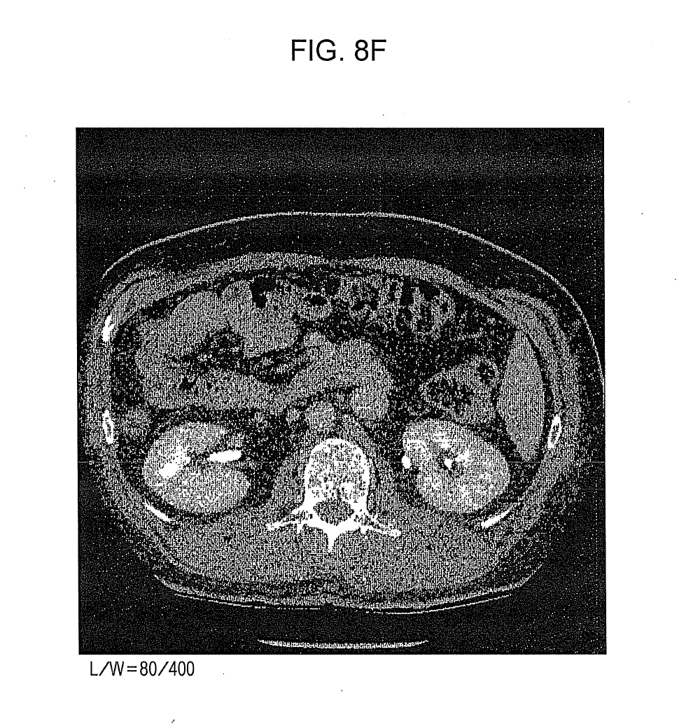

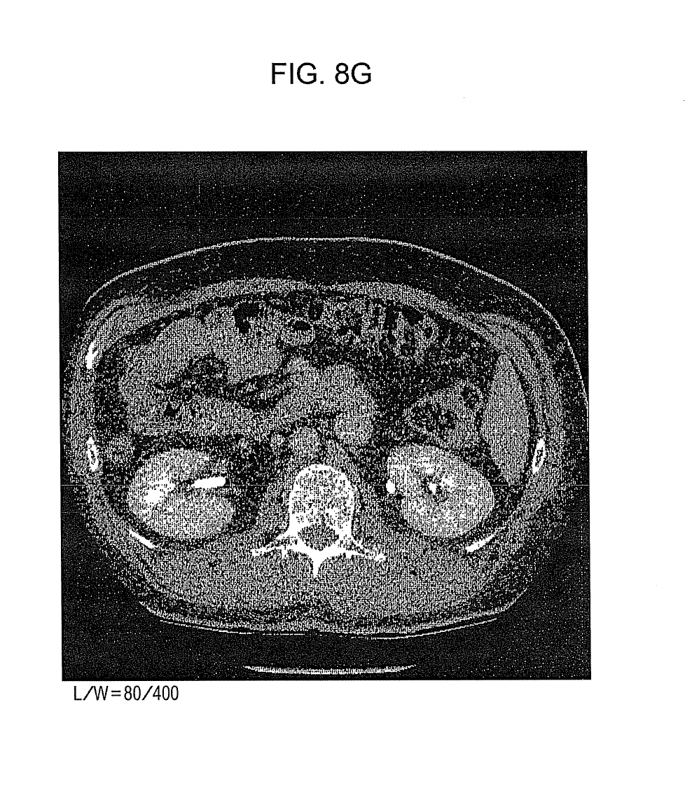

Now referring to FIGS. 8A through 8G illustrate the effects of the above described exemplary process of total variation iterative reconstruction (TV-IR) on a sample image according to the current invention. The following series of the images illustrates the effects of the exemplary process at different points of the total variation iterative reconstruction (TV-IR) according to the current invention. For the exemplary process, FIG. 8A illustrates an image that has been reconstructed by filtered backprojection (FBP) from projection data having 1200 views per revolution using 100 kV and 100 mAs. FIG. 8B illustrates an image that has been preprocessed by known procedures for noise reduction and corrections, and the preprocessed image is used as an initial seed for total variation iterative reconstruction (TV-IR) according to the current invention.

FIGS. 8C through 8G illustrate exemplary images at different points under the total variation iterative reconstruction (TV-IR). FIG. 8C illustrates an exemplary image that has gone under three iterations of the main loop as described with respect to FIG. 2 or 5. During the three iterations, the relaxation parameter or λ is adaptively set to 0.8. Also, during the three iterations, the TV steps are set to be two. That is, a number of iterations is adaptively set to two for the steps S30 and S40 in the sub loop or a total variation step (TVstep) loop in FIG. 2. By the same token, a number of iterations is adaptively set to two for the sub-loop or the total variation (TV) steps in lines 5 through 8 in FIG. 5.

FIG. 8D illustrates an exemplary image that has gone under a total of eight iterations of the main loop as described with respect to FIG. 2 or 5. In other words, during the first three iterations, the relaxation parameter or λ has been adaptively set to 0.8 while the TV steps have been set to be two as described with respect to FIG. 8C. Subsequently, during the next five iterations, the relaxation parameter or λ has been adaptively set to 0.2 while the TV steps have been set to be 0. That is, the TV steps are not performed.

FIG. 8E illustrates an exemplary image that has gone under a total of thirteen iterations of the main loop as described with respect to FIG. 2 or 5. In other words, during the first three iterations, the relaxation parameter or λ has been adaptively set to 0.8 while the TV steps have been set to be two as described with respect to FIG. 8C. Subsequently, during the next ten iterations, the relaxation parameter orλ has been adaptively set to 0.2 while the TV steps have been set to be 0. That is, the TV steps are not performed.

FIG. 8F illustrates an exemplary image that has gone under a total of eighteen iterations of the main loop as described with respect to FIG. 2 or 5. In other words, during the first three iterations, the relaxation parameter or λ has been adaptively set to 0.8 while the TV steps have been set to be two as described with respect to FIG. 8C. Subsequently, during the next fifteen iterations, the relaxation parameter or λ has been adaptively set to 0.2 while the TV steps have been set to be 0. That is, the TV steps are not performed.

FIG. 8G illustrates an exemplary image that has gone under a total of twenty-three iterations of the main loop as described with respect to FIG. 2 or 5. In other words, during the first three iterations, the relaxation parameter or λ has been adaptively set to 0.8 while the TV steps have been set to be two as described with respect to FIG. 8C. Subsequently, during the next twenty iterations, the relaxation parameter or λ has been adaptively set to 0.2 while the TV steps have been set to be 0. That is, the TV steps are not performed.

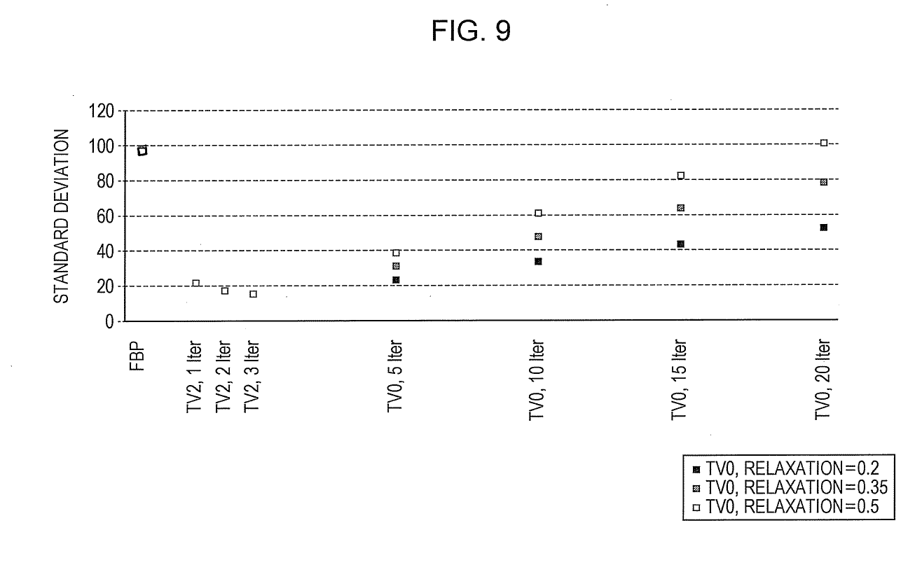

Now referring to FIG. 9, a graph plots a relation between the standard deviation in the image after certain iterations in the total variation iterative reconstruction (TV-IR) according to the current invention. The graph also includes the standard deviation for the original image and the preprocessed FBP seed image. The plotted data is not identical to the above described images in FIGS. 8A through 8G. For the first three iterations, the relaxation parameter or λ is adaptively set to 0.8. Also, during the three iterations, the TV steps are set to be two. That is, the TV steps are not performed. As the number of iterations increases to three, the standard deviation value decreases to indicate an improved noise level.

Still referring to FIG. 9, for the next twenty iterations, the relaxation parameter or λ is adaptively set to different values for the three cases. Also, during the twenty iterations, the TV steps are set to be 0. As the number of iterations increases to twenty, the standard deviation value in all of the three cases increases to indicate a worse noise level. The relaxation parameter or λ is adaptively set to 0.2, 0.35 and 0.5 in the three cases. The standard deviation value is best balanced at λ=0.35 between the image resolution and the noise level as indicated by standard deviation. Based upon the plot, the image quality may be better balanced between the fifth iterations and the tenth iteration.

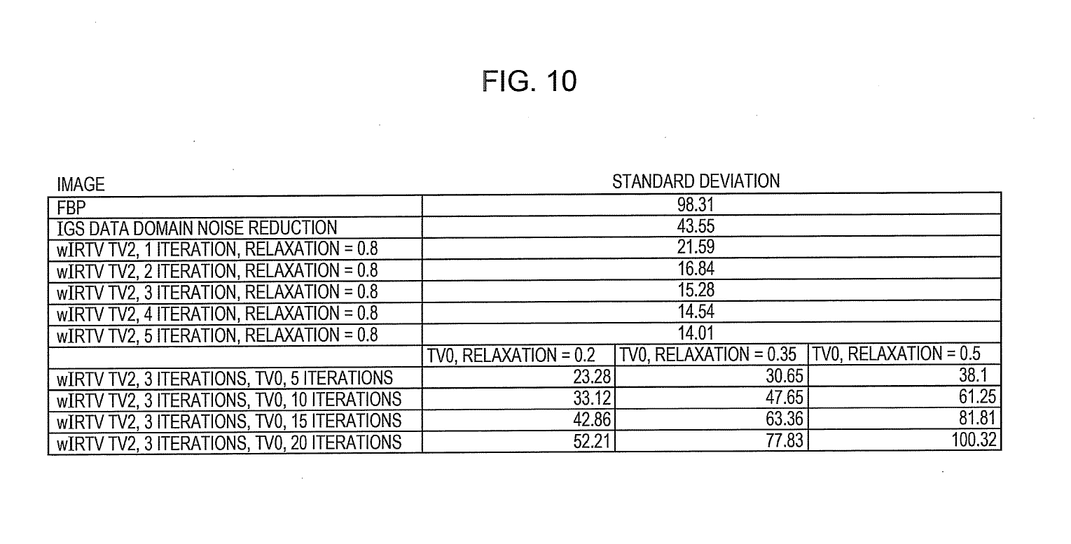

Now referring to FIG. 10, a table summarizes the standard deviation data for the images as plotted in the graph of FIG. 9. For the images, the standard deviation values are shown for the original or FBP, which is a filtered backprojection package . In addition, the standard deviation values are shown for the first through the fifth iteration each with the relaxation=0.8 and the TV step=2. For the subsequent images, the standard deviation values are shown for the fifth iteration, the tenth iteration, the fifteenth iteration and the twentieth iteration each with the TV step=2 and the relaxation=0.2, 0.35 and 0.5.

In general, the adaptive parameters have lesser values as the number of iteration increases in processing the image in the total variation iterative reconstruction (TV-IR) according to the current invention. That is, the above described three adaptive parameters are assigned their values based upon a current iteration value in the main-loop counter, and as the number of iterations increases these parameter values become smaller. In one example, the total variation counter has a value ranging from 0 to 5; the relaxation parameter has a value ranging from 0.2 to 1 and the step size parameter has a value ranging from 0.01 to 1.

In the above described examples, the three adaptive parameters are used, and all of the three values are adaptively assigned based upon a current iteration value in the main-loop counter. In another example, not all of these three values are adaptively assigned based upon a current iteration value in the main-loop counter. That is, in one example, only the total variation counter is adaptively assigned a value based upon a current iteration value in the main-loop counter while the relaxation parameter and the step size parameter each have a constant during the total variation iterative reconstruction (TV-IR) according to the current invention. In yet another example, a combination of the total variation counter and either the relaxation parameter or the step size parameter is adaptively assigned a respective value based upon a current iteration value in the main-loop counter during the total variation iterative reconstruction (TV-IR) according to the current invention. In this case, the relaxation parameter or the step size parameter has a constant if the parameter is not adaptively assigned a value based upon a current iteration value in the main-loop counter.

In the above described examples, sets of predetermined values are stored and later accessed for assigning to the three adaptive parameters. In another example, these values are determined on the fly based upon a predetermined condition in the main-loop counter rather than being stored in advance. These values are then adaptively assigned to the parameters. One example of the on-the-fly determination of the values is based upon current iteration value. Another example of the on-the-fly determination of the values is based upon an image processing tool such as an automatic noise assessment.

Furthermore, the above examples are disclosed in processing the image using the total variation iterative reconstruction (TV-IR) according to the current invention. That is, the above described three adaptive parameters are assigned their values based upon a current iteration value in the main-loop counter, and as the number of iterations increases these parameter values become smaller. In another example, the TV-IR is replaced by another iterative reconstruction algorithm without departing from the spirit of the current invention. For example, other iterative reconstruction algorithms include anisotropic diffusion (AD) where the amount of diffusion (iterations of AD) is the adaptive parameter whose value is adaptively modified. In this regard, any iterative reconstruction with a regularizer that functions as an adaptive parameter may be utilized according to the current invention provided that the strength of the regularization is adaptive according to an amount of iteration.

It is to be understood, however, that even though numerous characteristics and advantages of the present invention have been set forth in the foregoing description, together with details of the structure and function of the invention, the disclosure is illustrative only, and that although changes may be made in detail, especially in matters of shape, size and arrangement of parts, as well as implementation in software, hardware, or a combination of both, the changes are within the principles of the invention to the full extent indicated by the broad general meaning of the terms in which the appended claims are expressed.

What is claimed is:

1. A method of optimizing image reconstruction from projection data collected in a data acquisition device, comprising the steps of:
a) initializing an iteration counter, a total variation counter, a relaxation parameter and a step size parameter;
b) performing total variation minimization iterative reconstruction on the projection data based upon the relaxation parameter;
c) iteratively determining a step value from the step size parameter according to a predetermined rule;
d) adaptively minimizing the total variation using the step value;
e) repeating the steps c) and d) until the total variation counter indicates termination;
e) modifying the iteration counter to indicate completion of one iteration;
f) adaptively updating the total variation counter, the relaxation parameter and the step size parameter based upon the iteration counter; and
g) repeating the steps b) through f) until the iteration counter indicates termination.

2. The method of optimizing image reconstruction according to claim 1, wherein said a) initializing step initializes the iteration counter to a first predetermined number of iterations, the total variation counter to a second predetermined initial number, the relaxation parameter to an initial relaxation value and the step size parameter to an initial step size value.

3. The method of optimizing image reconstruction according to claim 2, wherein the total variation counter is decremented by one before said e) repeating step.

4. The method of optimizing image reconstruction according to claim 2, wherein the iteration counter is decremented by one in said e) modifying step.

5. The method of optimizing image reconstruction according to claim 1, wherein said f) adaptively updating step assigns to the total variation counter one of predetermined total variation repeat values that corresponds to a current value in the iteration counter.

6. The method of optimizing image reconstruction according to claim 1, wherein said f) adaptively updating step assigns to the relaxation parameter one of predetermined relaxation values that corresponds to a current value in the iteration counter.

7. The method of optimizing image reconstruction according to claim 1, wherein said f) adaptively updating step assigns to the step size parameter one of predetermined step size values that corresponds to a current value in the iteration counter.

8. The method of optimizing image reconstruction according to claim 1, wherein said b) performing step utilizes an ordered subset simultaneous algebraic reconstruction technique (OSSART).

9. The method of optimizing image reconstruction according to claim 1, the total variation counter has a value ranging from 0 to 5.

10. The method of optimizing image reconstruction according to claim 1, the relaxation parameter has a value ranging from 0.2 to 1.

11. The method of optimizing image reconstruction according to claim 1, the step size parameter has a value ranging from 0.01 to 1.

12. The method of optimizing image reconstruction according to claim 1, wherein said f) adaptively updating step updates any combination of the total variation counter, the relaxation parameter and the step size parameter on the fly based upon the iteration counter.

13. A system for optimizing image generation, comprising:
a data acquisition unit for obtaining projection data collected; and
an image processing unit connected to said data acquisition unit for initializing an iteration counter, a total variation counter, a relaxation parameter and a step size parameter, said processing unit performing an iteration by total variation minimization iterative reconstruction on the projection data based upon the relaxation parameter, said processing unit iteratively determining a step value from the step size parameter according to a predetermined rule and adaptively minimizing the total variation using the step value until the total variation counter indicates termination, said processing unit modifying the iteration counter to indicate completion of one iteration and adaptively updating the total variation counter, the relaxation parameter and the step size parameter based upon the iteration counter, said processing unit repeating the iteration until the iteration counter indicates termination.

14. The system for optimizing image generation according to claim 13, wherein said image processing unit initializes the iteration counter to a first predetermined number of iterations, the total variation counter to a second predetermined initial number, the relaxation parameter to an initial relaxation value and the step size parameter to an initial step size value.

15. The system for optimizing image generation according to claim 14, wherein said image processing unit decrements the total variation counter by one.

16. The system for f optimizing image generation according to claim 14, wherein said image processing unit decrements the iteration counter by one.

17. The method of optimizing image generation according to claim 13, wherein said image processing unit adaptively updates the total variation counter by assigning one of predetermined total variation repeat values that corresponds to a current value in the iteration counter.

18. The system for optimizing image generation according to claim 13, wherein said image processing unit adaptively updates the relaxation parameter by assigning one of predetermined relaxation values that corresponds to a current value in the iteration counter.

19. The system for optimizing image generation according to claim 13, wherein said image processing unit adaptively updates the step size parameter by assigning one of predetermined step size values that corresponds to a current value in the iteration counter.

20. The system for optimizing image generation according to claim 13, wherein said image processing unit performs an ordered subset simultaneous algebraic reconstruction technique (OSSART).

21. The system for optimizing image generation according to claim 13, the total variation counter has a value ranging from 0 to 5.

22. The system for optimizing image generation according to claim 13, the relaxation parameter has a value ranging from 0.2 to 1.

23. The system for optimizing image generation according to claim 13, the step size parameter has a value ranging from 0.01 to 1.

24. The system for optimizing image generation according to claim 13, wherein said image processing unit adaptively updates any combination of the total variation counter, the relaxation parameter and the step size parameter on the fly based upon the iteration counter.

25. A method of optimizing image reconstruction from projection data collected in a data acquisition device, comprising the steps of:
a) initializing an iteration counter, a total variation counter, a relaxation parameter and a step size parameter;
b) performing total variation minimization iterative reconstruction on the projection data based upon the relaxation parameter;
c) iteratively determining a step value from the step size parameter according to a predetermined rule;
d) adaptively minimizing the total variation using the step value;
e) repeating the steps c) and d) until the total variation counter indicates termination;
e) modifying the iteration counter to indicate completion of one iteration;
f) adaptively updating the total variation counter based upon the iteration counter; and
g) repeating the steps b) through f) until the iteration counter indicates termination.

26. The method of optimizing image reconstruction according to claim 25, wherein said f) adaptively updating step additionally updates the relaxation parameter based upon the iteration counter.

27. The method of optimizing image reconstruction according to claim 25, wherein said f) adaptively updating step additionally updates the step size parameter based upon the iteration counter.

28. The method of optimizing image reconstruction according to claim 25, wherein said a) initializing step initializes the iteration counter to a first predetermined number of iterations, the total variation counter to a second predetermined initial number, the relaxation parameter to an initial relaxation value and the step size parameter to an initial step size value.

29. The method of optimizing image reconstruction according to claim 28, wherein the total variation counter is decremented by one before said e) repeating step.

30. The method of optimizing image reconstruction according to claim 28, wherein the iteration counter is decremented by one in said e) modifying step.

31. The method of optimizing image reconstruction according to claim 25, wherein said f) adaptively updating step assigns to the total variation counter one of predetermined total variation repeat values that corresponds to a current value in the iteration counter.

32. The method of optimizing image reconstruction according to claim 26, wherein said f) adaptively updating step assigns to the relaxation parameter one of predetermined relaxation values that corresponds to a current value in the iteration counter.

33. The method of optimizing image reconstruction according to claim 27, wherein said f) adaptively updating step assigns to the step size parameter one of predetermined step size values that corresponds to a current value in the iteration counter.

34. The method of optimizing image reconstruction according to claim 27, wherein said b) performing step utilizes an ordered subset simultaneous algebraic reconstruction technique (OSSART).

35. The method of optimizing image reconstruction according to claim 25, the total variation counter has a value ranging from 0 to 5.

36. The method of optimizing image reconstruction according to claim 26, the relaxation parameter has a value ranging from 0.2 to 1.

37. The method of optimizing image reconstruction according to claim 27, the step size parameter has a value ranging from 0.01 to 1.

38. A system for optimizing image generation, comprising:
a data acquisition unit for obtaining projection data collected; and
an image processing unit connected to said data acquisition unit for initializing an iteration counter, a total variation counter, a relaxation parameter and a step size parameter, said processing unit performing an iteration by total variation minimization iterative reconstruction on the projection data based upon the relaxation parameter, said processing unit iteratively determining a step value from the step size parameter according to a predetermined rule and adaptively minimizing the total variation using the step value until the total variation counter indicates termination, said processing unit modifying the iteration counter to indicate completion of one iteration and adaptively updating the total variation counter based upon the iteration counter, said processing unit repeating the iteration until the iteration counter indicates termination.

39. The system for optimizing image generation according to claim 38, wherein said image processing unit additionally updates the relaxation parameter based upon the iteration counter.

40. The system for optimizing image generation according to claim 38, wherein said image processing unit additionally updates the step size parameter based upon the iteration counter.

41. The system for optimizing image generation according to claim 38, wherein said image processing unit initializes the iteration counter to a first predetermined number of iterations, the total variation counter to a second predetermined initial number, the relaxation parameter to an initial relaxation value and the step size parameter to an initial step size value.

42. The system for optimizing image generation according to claim 41, wherein said image processing unit decrements the total variation counter by one.

43. The system for f optimizing image generation according to claim 41, wherein said image processing unit decrements the iteration counter by one.

44. The system for optimizing image generation according to claim 38, wherein said image processing unit adaptively updates the total variation counter by assigning one of predetermined total variation repeat values that corresponds to a current value in the iteration counter.

45. The system for optimizing image generation according to claim 39, wherein said image processing unit adaptively updates the relaxation parameter by assigning one of predetermined relaxation values that corresponds to a current value in the iteration counter.

46. The system for optimizing image generation according to claim 40, wherein said image processing unit adaptively updates the step size parameter by assigning one of predetermined step size values that corresponds to a current value in the iteration counter.

47. The system for optimizing image generation according to claim 38, wherein said image processing unit performs an ordered subset simultaneous algebraic reconstruction technique (OSSART).

48. The system for optimizing image generation according to claim 38, the total variation counter has a value ranging from 0 to 5.

49. The system for optimizing image generation according to claim 39, the relaxation parameter has a value ranging from 0.2 to 1.

50. The system for optimizing image generation according to claim 40, the step size parameter has a value ranging from 0.01 to 1.

51. A method of optimizing image reconstruction from projection data collected in a data acquisition device, comprising the steps of:
a) initializing a counter and at least one adaptive parameter;
b) performing a predetermined iterative reconstruction technique on the projection data based upon the adaptive parameter;
c) adaptively updating the adaptive parameter;
d) iteratively performing said steps b) and c) until said step b) reaches a predetermined termination condition.

52. The method of optimizing image reconstruction according to claim 51 wherein said predetermined iterative reconstruction technique includes total variation minimization iterative reconstruction.

53. The method of optimizing image reconstruction according to claim 51 wherein said predetermined iterative reconstruction technique includes anisotropic diffusion.

54. A system for optimizing image generation, comprising:
a data acquisition unit for obtaining projection data collected; and
an image processing unit connected to said data acquisition unit for initializing a counter and at least one adaptive parameter, said image processing unit performing a predetermined iterative reconstruction technique on the projection data based upon the adaptive parameter, said image processing unit adaptively updating the adaptive parameter and iteratively performing the predetermined iterative reconstruction technique until a predetermined termination condition.

55. The method of optimizing image reconstruction according to claim 54 wherein the predetermined iterative reconstruction technique includes total variation minimization iterative reconstruction.

56. The method of optimizing image reconstruction according to claim 54 wherein the predetermined iterative reconstruction technique includes anisotropic diffusion.
